(19) United States
(12) Patent Application Publication
(10) Pub. No.: US 2020/0402445 A1
(43) Pub. Date: Dec. 24, 2020

(54) Software Based Partial Display Dimming

(71) Applicant: Intel Corporation, Santa Clara, CA (US)

(72) Inventors: Celia Hua-Mei Yang, Taipei (TW); Ivan Chen, Taipei (TW); Sravan Akepati, Hillsboro, CA (US); Yong-Joon Park, Hlllsboro, CA (US); Jackson Tsai, Taipei (TW); Lyndon Feng, Taipei (TW); Ajay Saini, Hillsboro, CA (US)

(21) Appl. No.: 16/800,944

(22) Filed: Feb. 25, 2020

(51) Int. Cl. G09G 3/20; G09G 3/3208; G06F 1/3234; G06F 1/3231

(52) U.S. Cl. CPC G09G 3/2007; G09G 3/3208; G09G 2330/022; G06F 1/3231; G06F 1/3265

(57) ABSTRACT

Some embodiments provide a method including determining one or more areas of a display to remain active responsive to received user input, determining one or more areas to be dimmed responsive to the received user input, and dimming the one or more areas of the display to be dimmed to reduce a power consumption of the display. The user input may include mouse cursor, keyboard, touch, eye position or movement information, voice commands, or a power policy of an electronic device including the display. The dimming may include dimming pixels of the display in the one or more areas of the display to be dimmed or changing a color of such pixels. The display may include multiple displays and the dimming including dimming areas on multiple ones of displays, including turning off one or more of the displays. The dimming may be turned and off based on user input.

### BACKGROUND

The present disclosure relates to the reduction of power consumption in electronic devices, and more specifically to the reduction of electrical power consumed by a display of an electronic device.

In many electronic devices, such as laptop and notebook computers and mobile devices such as smart phones, a display of the electronic device is one of the highest power consuming components of the electronic device. These types of electronic devices are typically powered by battery power during use at least some of the time. Thus, this relatively high-power consumption of the display in such electronic devices reduces the battery life when the electronic device is being operated on battery power, where the battery life is the time for which the battery can power the electronic device.

Prior approaches have been considered to reduce power consumption of displays in electronic devices. One such approach dims or reduces the intensity of the light emitted by the display to thereby reduce power consumption. Other approaches have been utilized in displays that utilize display backlighting such as a liquid crystal display (LCD). Whether an image being displayed does not use a full color range of the display is detected, the color range of the display adjusted, and backlighting reduced to thereby maintain a visually similar image while reducing the backlighting power consumption of the display. While these prior approaches may provide some power savings, additional hardware circuitry may be required, increasing the cost of the display. Moreover, the percentage power reduction and corresponding extension of battery life realized by these prior approaches are limited. Accordingly, improved approaches for reducing the power consumption of displays in electronic devices are desirable.

### BRIEF DESCRIPTION OF THE DRAWINGS

FIG. 1 is a functional diagram illustrating a display power-reduction system and process according to one embodiment of the present disclosure;

FIG. 2 illustrates multiple displays in which the process of FIG. 1 may change characteristics of multiple windows being presented on each display to reduce power consumption of the displays according to one embodiment;

FIG. 3 is a flowchart illustrating a desktop composition process according to one embodiment;

FIG. 4 is a flowchart illustrating a graphics driver process that performs partial display dimming when called by the desktop composition process of FIG. 3 according to an embodiment;

FIG. 5 is a flowchart illustrating a dimming shader process called by the graphics driver process of FIG. 4 when partial display dimming is enabled;

FIG. 6 is a flowchart illustrating a query plugin process utilized by the dimming shader process of FIG. 5 to process inputs identifying regions of the display to be dimmed;

FIG. 7 is a sequence diagram illustrating operation of the various software components that implement a display power-reduction process according to the embodiments of FIGS. 3-6;

FIG. 8 is a functional block diagram of an example computer system illustrating a sample environment in which embodiments of the present disclosure may be implanted.

### DETAILED DESCRIPTION

In the following description, for purposes of explanation, numerous examples and specific details are set forth in order to provide a thorough understanding of the present disclosure. Such examples and details are not to be construed as unduly limiting the elements of the claims or the claimed subject matter as a whole. It will be evident to one skilled in the art, based on the language of the different claims, that the claimed subject matter may include some or all of the features in these examples, alone or in combination, and may further include modifications and equivalents of the features and techniques described herein.

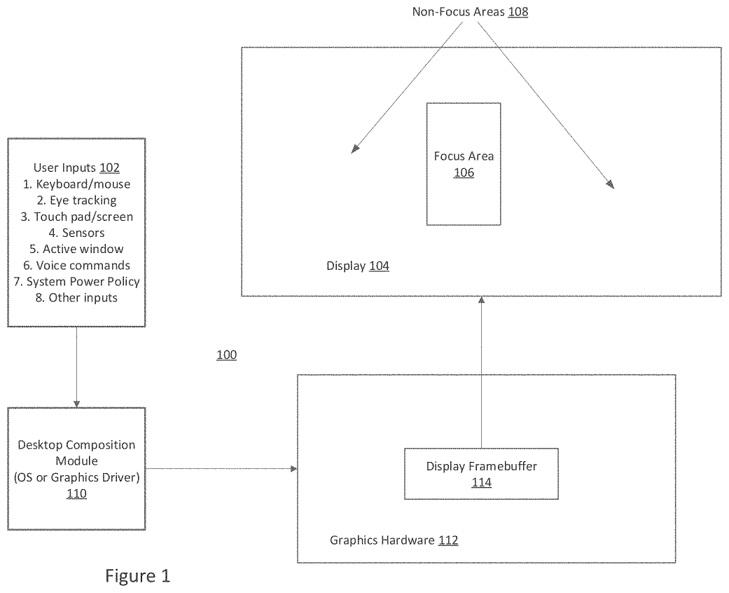

FIG. 1 is a functional diagram illustrating a display power-reduction system and process 100 according to one embodiment of the present disclosure. In operation, the display power-reduction process 100 receives user inputs 102 and based on these user inputs controls the rendering or display of content on a display 104 in one or more focus areas 106 on the display, and also controls dimming of the display in one or more non-focus areas 108 of the display to thereby reduce power consumption of the display, as will be explained in more detail below. In this way, the process 100 maintains active the one or more focus areas 106 of the display 104, which are the areas being viewed or are most likely to be viewed by the user, at standard brightness for these areas. The process 100 determines these focus areas 106 based on the user input 102. The process 100 also reduces the brightness of or dimming of the brightness of the inactive or non-focus areas 108 of the display 104, which are the area or areas not being viewed or are less likely as being viewed by the user. The process 100 also determines these non-focus areas 108 based on the user inputs 102. This maintaining of the intensity or brightness of the focus areas 106 while dimming the non-focus areas 108 on the display is referred to as “partial dimming” in the present application.

The user inputs 102 utilized in the display power-reduction process 100 may include a wide variety of different types of inputs provided by or received from a user, or through settings or from software running in the environment in which the process 100 is being implemented. The process 100 would typically be implemented in a portable electronic device such as, for example, a smart phone, tablet computer, or laptop computer, but is not limited to being implemented in these types of electronic devices. The display power-reduction process 100 may be implemented in any other suitable type of electronic device including a display and which may benefit from reducing the power consumption of the display. In such an environment, the user inputs 102 received in the display power-reduction process 100 may include cursor information received from a mouse, keystroke information received from a keyboard, touch information received from a touch screen of the display 104, a position of or movement of the eyes of the user indicating a location on the display where the user is looking, voice commands from the user or a power policy setting of the electronic device including the display, software running on the electronic device, or through manual input from the user. In some embodiments, where the display 104 includes a touch screen, the process 100 may identify the focus area or areas 106 based on locations on the display 104 that are touched by the user. Alternatively, in some embodiments the process 100 determines the focus area 106 based on where a cursor is positioned on the display 104. These user inputs 102 are provided by way of example, and the display power-reduction process 100 is not limited to utilizing only some or all these user inputs, but may utilize other inputs in addition to or in place of these example user inputs.

In some embodiments, the user inputs 102 also include an input that enables and disables execution of the display power-reduction process 100. For example, where the user inputs 102 include a power policy setting, the process 100 may be activated or enabled once a charge level of a battery of the electronic device including the display 104 drops below a selected charge percentage. Similarly, once the charge level of the battery reaches a selected threshold after being charged, the process 100 may then be deactivated or disabled. In some embodiments, the user inputs 102 may include an ON/OFF parameter that is manually selectable or input by the user to thereby enable the user to manually enable and disable execution of the display power reduction process 100. This allows the user to manually select execution of the process 100 independent of the other user input 102. For example, where the user is almost done with a task being performed on the electronic device and the battery reaches a level that causes the process 100 to be executed, the user may, through the ON/OFF parameter, disable the process and finish the task under normal operating conditions of the electronic device.

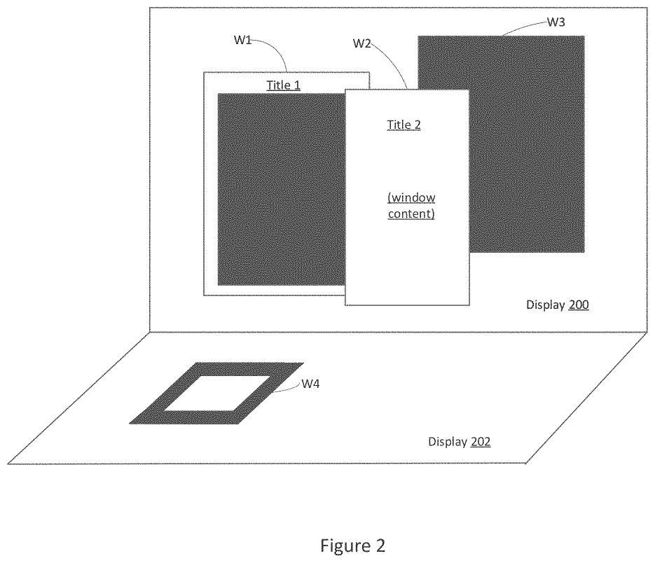

In the display power-reduction process 100, once the user inputs 102 are collected or received, these inputs are processed by a desktop composition module (DCM) 110 to control partial dimming of the display 104. The DCM 110 is a software component that executes as part of an operating system (OS) of the electronic device including the display 104, executes as part of a graphics driver of the electronic device, or executes as part of both the OS and graphics driver. The DCM 110 implements the partial dimming of the display 104 and part of this overall process includes compositing windows manager functionality that composites contents or images of multiple applications executing on the electronic device into a desktop screen or image to be displayed on the display 104. Where the electronic device includes more than one display 104, as will be described in more detail below with reference to FIG. 2, the DCM 100 composites images from the running applications into a desktop image that is displayed on these multiple displays.

The operation of a compositing windows manager, such as the desktop windows manager (DWM) in the Windows operation system, and a graphics driver will be understood by those skilled in the art, and thus these software component will not be described in detail herein. Aspects of the operation of the graphics driver and compositing windows manager that are part of the overall operation of the DCM 110 will, however, now be briefly described to enable a better understanding of aspects of the partial dimming of the display 104 implemented through the DCM in the process 100. As seen in FIG. 1, the electronic device in which the process 100 is implemented includes graphics hardware 112, which includes a graphics processing unit (GPU) (not shown) of the device. The graphics driver is a software component that allows the OS, as well as programs or applications executing on the electronic device, to control the graphics hardware 112 to display desired images on the display 104.

Each application executing on the electronic device is displayed in a corresponding window on the desktop displayed on the display 104. An image to be displayed by each executing application is stored in a corresponding off-screen buffer associated with each window on the display 104. During execution of the applications, the images stored in the corresponding off-screen buffers are occasionally updated and the compositing windows manger thereafter processes each of the updated images as part of generating a corresponding composite image to be displayed as the desktop on the display 104. The processing of these respective images in the off-screen buffers may include applying 2D and 3D effects, and may include operations such as blending, fading, scaling, rotation, duplication, bending and contortion, shuffling, blurring, redirecting applications, translating windows into one of a number of displays and virtual desktops, and other graphics-related operations, as will be understood by those skilled in the art. The graphics hardware 112 generates the composite image that is then stored in a display framebuffer 114 as seen in FIG. 1, with this stored composite image being stored in either dedicated memory or system memory (not shown) and thereafter being displayed as the desktop on the display 104.

Returning to the description of the DCM 110, the DCM includes either a modified compositing windows manager, a modified graphics driver, or a modified compositing manager and graphics driver, to implement partial dimming on the display 104. Each of the compositing windows manger and graphics driver is a software component, and thus modification of these components includes programming instructions added to one or both of these components to implement the partial dimming functionality. In operation, the DCM 100 receives the user inputs 102 and from these user inputs determines one or more focus areas 106 on the display 104 that are to remain active (i.e., the intensity or brightness in these focus areas are maintained). The DCM also determines, based on the user input 102, one or more non-focus areas 104 of the display 104 which are to be dimmed (i.e., the intensity or brightness in these non-focus areas are to be reduced or dimmed). The DCM 110 thereafter, through execution of the modified compositing windows manager, modified graphics driver, or modified compositing windows manager and graphics driver, dims the one or more non-focus areas 108 of the display to be dimmed to reduce a power consumption of the display 104.

The specific way the DCM 110 controls the dimming of the non-focus areas 108 on the display 104 will depend on the specific type of the display. For example, where the display 104 is an organic LED (OLED) display, the DCM may dim (i.e., reduce the intensity or brightness of) at least some of the pixels of the display 104 in the one or more non-focus areas 108 of the display to be dimmed. This dimming of the non-focus areas 108 may include changing a color of at least some of the pixels of the display 104 in the one or more non-focus areas 108. The color of these pixels may, for example, be changed to a darker color, such as blue or black. Where the display 104 includes segmented LED backlighting, the dimming may include turning OFF one or more segments of the backlighting of the display. For example, the display 104 may be an LCD with mini LED backlighting where dimming is performed by controlling groups of the mini LEDs.

FIG. 2 illustrates multiple displays 200 and 202 in which the process 100 of FIG. 1 may change characteristics of multiple windows W1, W2, W3, W4 being presented on the multiple displays to reduce overall power consumption of the displays according to one embodiment. The windows W1-W3 are presented on the display 200 and window W4 on display 202. In such a multiple display electronic device, the process 100 may implement partial dimming on each of the display 200, 202. Furthermore, in such a multiple display device one of the displays 200, 202 may not be utilized by a user at certain times. For example, assume the window W4 is not being displayed on the display 202 such that no windows are presented on this display. In this situation, the dimming performed by the process 100 may include dimming the entire display 202. The partial dimming implemented by the process 100 may include dimming the entire display for one or more of the displays 200, 202 in a multiple display device.

FIG. 2 also illustrates that dimming performed by the process 100 in each of the windows W1-W4 may vary in different embodiments. In the example to be discussed, assume the window W4 is not displayed on the display 202 such that no windows are present on this display. In this situation, the windows W1-W3 are present on the display 200 and the window W2 is the active window (i.e., is the focus area on the display 200). The windows W1 and W3 are inactive or non-focus areas on the display 200 in this example. The process 100 will accordingly dim the windows W1, W3, and FIG. 2 shows two examples of how this dimming within a given inactive window (i.e., in non-focus areas) may be performed. In the window W3, the entire window is dimmed. Thus, each of the pixels in the window W3 is set to black or changed to some other darker color to reduce the power consumption of the display 200 due to displaying the window W3. Where the display 200 includes segmented LED backlighting, dimming window W3 may include turning off one or more segments of the backlighting of the display. The window W1 shows another possible way of dimming an inactive window corresponding to a non-focus area of the display. The window W1 includes a border around the perimeter of the window that is not dimmed but remains illuminated by the DCM 110 (FIG. 1) while an interior of the window W1 inside this border is dimmed.

Other embodiments include other ways of dimming inactive windows (i.e., non-focus areas) on a display. For example, dimming inactive windows or non-focus areas occurs in different ways in further embodiments, such as by changing colors in the inactive windows or non-focus areas, or through gradient dimming within the inactive windows or non-focus areas, or through gradient dimming at edges between the one or more focus areas and the non-focus areas. The inactive windows or non-focus areas may be defined through eye tracking to identify a moving focus area (active window or windows) and non-focus areas (inactive window or windows) in the other areas of the display. In other embodiments, the size of the entire screen being displayed can be shrunk to a smaller area (focus area) on the display, with the remaining area (non-focus area) on the screen being dimmed or turned OFF. In other embodiments a window or windows associated with a given app are defined as the active window or windows and thereby as the focus area that is not dimmed, or is dimmed in a particular manner, while the windows of other apps are defined as non-focus areas and are accordingly dimmed. In another embodiment, portions of each active window of a given app may also be dimmed such as by dimming an edge portion of each active window for the given app, which is illustrated for the window W4 in FIG. 2. Thus, where the window W4 is an active window of a particular app running on an electronic device, this active window W4 may be dimmed around the edges of the window as shown. Content being presented by the app is displayed on the interior portion of the active window W4 in this embodiment, which is represented by the interior white portion of the window W4. The dimming around the edge of the active window W4 could alternatively be a gradient dimming, or this dimming could be done through displaying a particular color in the edge portion of the window, or through other suitable dimming techniques that reduce power consumed by the display 202 in displaying the window W4.

In another embodiment, a user may provide manual input, such as through touch input, voice input, or keystrokes, to instantly enable the display power reduction process 100 on the corresponding electronic device. The user could similarly disable the process 100 through manual input in this embodiment. Also, in this embodiment, the user could provide other manual input after enabling the process 100 to thereby provide various inputs that control the operation of the process 100, such as providing levels of dimming to be provided. In another embodiment, the user may also manually define focus and non-focus areas, or active and non-active windows through suitable manual input such as touch input, voice input, or keystrokes. For example, the user could through a first type of touch stroke on the display define a focus area or areas and through a second type of touch stroke define non-focus areas on the display.

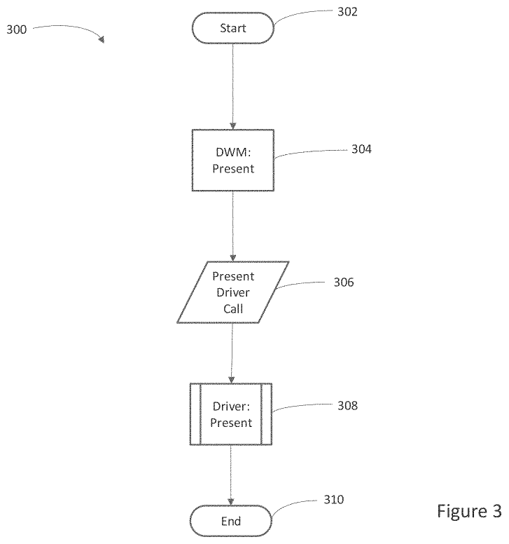

FIG. 3 is a flowchart illustrating a desktop composition process 300 that is part of the display power-reduction process 100 according to one embodiment. The process 300 is an example of a process executed by the windows compositing manager, which in the example of FIG. 3 is the DWM in the Windows OS. FIGS. 3-7 illustrate an example embodiment of the DCM 110 implemented in the Windows OS such that the compositing windows manager is DWM and the partial dimming is implemented through a modified graphics driver of the electronic device. The desktop composition process 300 starts at 302 and proceeds immediately to 304 where the DWM makes a Present call, where Present is a function of the DWM that calls the graphics driver. Next, the process 300 at 306 and 308 receives from the graphics driver the partial dimming modified image data of each of the windows being displayed on the desktop. At 308, the process 300 provides the composite image as modified by the partial dimming modified image data to the display framebuffer 114 (FIG. 1) for display on the display 104.

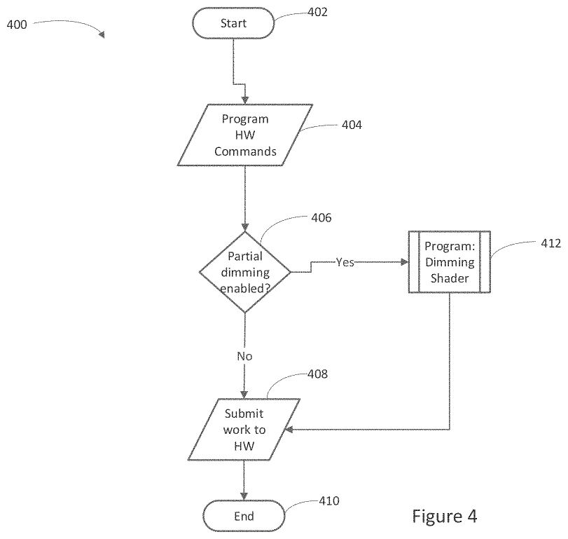

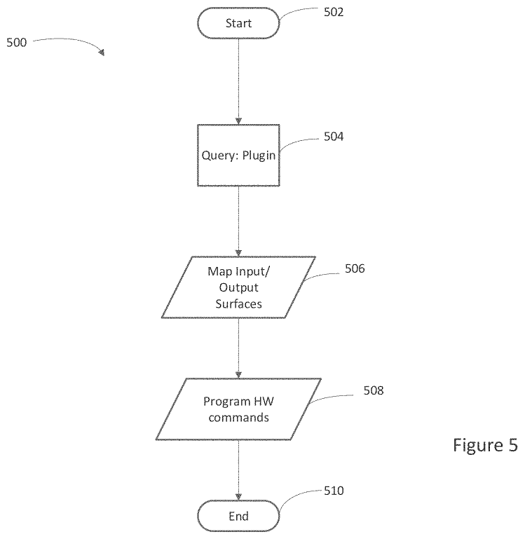

FIG. 4 is a flowchart illustrating a graphics driver process 400 corresponding executed by the graphics driver in response to the Present call from the DWM executing the desktop composition process 300 of FIG. 3. The process 400, at 402, starts and then proceeds to 404 in which the graphics driver generates commands for programing the graphics hardware 112 (FIG. 1). Next, at 406, the process 400 determines whether partial dimming of the display 104 is enabled. If the determination at 406 is negative, the process 400 proceeds to 408 and the programmed hardware commands are submitted to the graphics hardware 112. Next, the process 400 at 410 terminates. Where the determination at 406 is positive, the process at 412 executes a dimming shader program or process to perform partial dimming of the desktop image, as will be described in more detail below with reference to FIG. 5. The process 400 thereafter terminates at 410.

FIG. 5 is a flowchart illustrating a dimming shader process 500 called by the graphics driver process 400 of FIG. 4 when partial display dimming is enabled as determined at 406 of the process 400. The process 500 starts at 502 and proceeds to 504 where a query function is executed in the form of a query plugin in the example embodiment of FIG. 5. The query plugin obtains user inputs 102 from the OS and utilizes these inputs to determine which areas on the display 104 are focus areas 106 (i.e., are not to be dimmed) and which areas are non-focus areas 108 (i.e., are to be dimmed). Next, the process 500 at 506 maps input and output surfaces using data from the query plugin executed at 504 and these mapped input and output surfaces are utilized to modify the composited desktop image to perform partial dimming on this image. At 508 the process 500 programs the graphics hardware 112 (FIG. 1) to perform the determined partial dimming. The process 500 then terminates at 510.

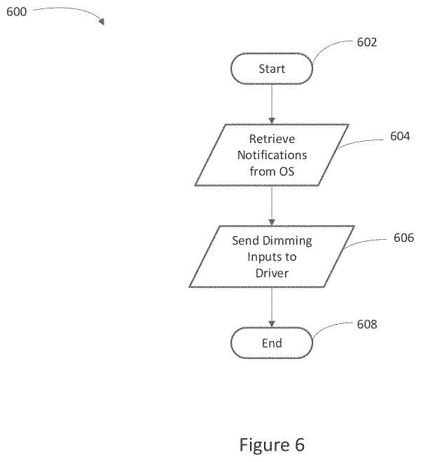

FIG. 6 is a flowchart illustrating a query plugin process 600 executed by the query plugin executed by the process 500 at 504. The process 600 starts at 602 and to 604 at which the process receives user input 102 in the form of notifications from the OS of the electronic device. The OS maintains information on the size and location of opened windows on the display 104, and the process 600 at 604 retrieves this information as well for use by the graphics driver programming the graphics hardware 112 to perform the desired partial dimming. Next, at 606 the process 600 provides the retrieved user inputs 102 and from the OS to the dimming shader process 500 for use in partial dimming of the display 104.

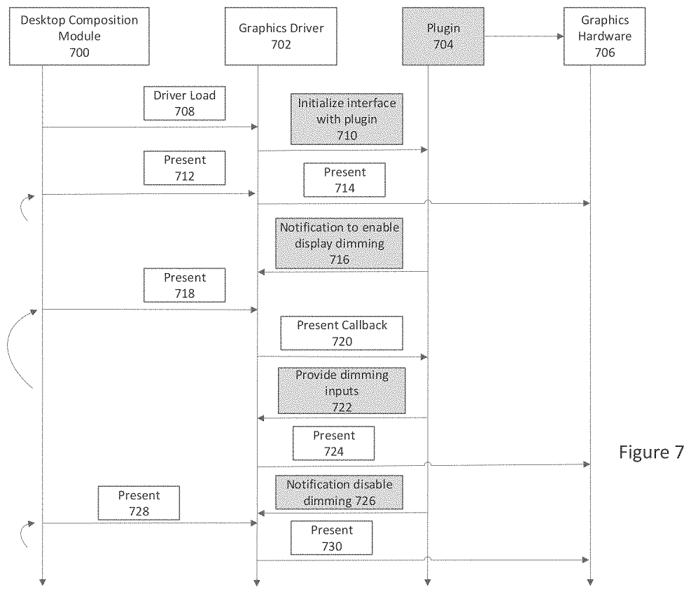

FIG. 7 is a sequence diagram illustrating operation of the various software components of FIGS. 1-6 that implement the desktop composition process 300 of FIG. 3 including partial dimming implemented by the graphics driver in this embodiment. In the embodiment of FIG. 7, the white boxes illustrate existing components and operation while the gray shaded boxes illustrate new components included to perform the desired partial dimming. Along the top of the sequence diagram of FIG. 7 are shown the pertinent software components, namely desktop composition module 700, graphics driver 702, plugin 704 and graphics hardware 706. Each of these components 700-706 corresponds to components previously described with reference to FIGS. 1-6.

As shown in FIG. 7, the desktop composition module 700 load the graphics driver 702 at 708 and at 710 the graphics driver initializes the plugin 704. At this point, the partial dimming is not enabled since the partial dimming is only utilized in the electronic device when necessary. As a result, at 712 when the desktop composition module 700 initially makes a Present call to the graphics driver 702, the Present call at 714 from the graphics driver to the graphics hardware 706 results in programming of the graphics hardware in a conventional manner to display the composite desktop image on the display 104 (FIG. 1).

At 716, the plugin 704 determines that partial dimming is to be performed and provides a notification to the graphics driver 702 indicating partial dimming is now enabled. As a result, at 718, when the desktop composition module 700 makes a Present Call to the graphics driver 702, a call to the plugin 704, which is indicated as a Present Callback at 720, is made and the plugin 704 returns at 722 dimming inputs to the graphics driver 702. These dimming inputs include the notifications retrieved from the OS as discussed above with reference to FIG. 6. Next, at 724 the graphics driver 720 makes a Present call to program of the graphics hardware 706 to perform the required partial dimming and display the composite desktop image on the display 104 (FIG. 1) including this partial dimming. At 726, the plugin 704 provides a notification that partial dimming to be disabled, such as would typically occur when the battery of the electronic device has been recharged, and because of this, or for some other reason, the partial dimming is no longer required. For example, the user may manually disable partial dimming, as discussed above. After partial dimming has been disabled at 726, when the desktop composition module 700 makes another Present call at 728 to the graphics driver 702, and the graphics driver makes a Present call at 730 that results in programming of the graphics hardware 706 at 730 in a conventional manner to display the composite desktop image on the display 104 (FIG. 1).

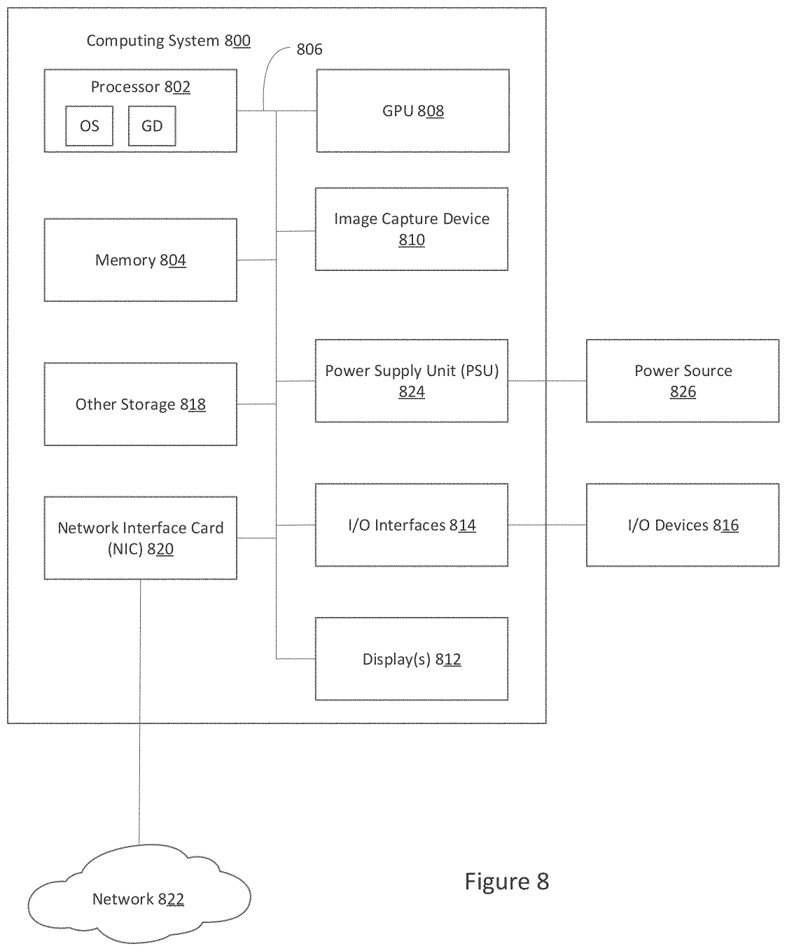

FIG. 8 is a functional block diagram illustrating an example of a computing system 800 to implement the display power-reduction techniques discussed herein with reference to the embodiments of FIGS. 1-7. The computing system 800 may be, for example, a mobile device such as a smart phone, laptop computer, ultrabook, tablet computer, a desktop computer, or a server or other type of computer system that would benefit from the display power-reduction techniques of the present application. The computer system 800 would typically be a mobile device running on battery power, which would then utilize the display power-reduction techniques of the present application to extend the life of battery for a given charge by lowering the power consumption of the system. The computer system 800 need not be a mobile device, however, where there is a need to reduce the power consumption of the system even though the deice is not being powered through battery power. Finally, the computer system 800 of FIG. 8 illustrates an example of a suitable computing system environment in which embodiments of the present disclosure may be implemented. The computing system 800 is an example of one suitable computing environment should not be considered to suggest any limitation as to the implementations of embodiments of the present disclosure.

In the example embodiment of FIG. 8, the computing system 800 includes a processor 802, such as a central processing unit, which is configured to execute stored instructions. A memory device 804 stores instructions that are executable by the processor 802, and may be any suitable type of memory such as read only memory (ROM), dynamic random access memory (DRAM), static random access memory (SRAM), flash memory (FLASH), or a combination these and other different types of memory. The memory device 804 stores instructions executed by the processor 802, including instructions of OS and graphics driver GD loaded into memory, and instructions executed by the processor to implement the display power-reduction processes of FIGS. 1-7. The processor 802 is coupled to the memory device 804 through a bus 806 of the computer system 800. The processor 802 may be a single core processor, a multi-core processor, a computing cluster, or any number of other configurations. Furthermore, the computing system 800 may include more than one processor 802 and more than one memory device 804.

The computing system 800 further includes a graphics processing unit (GPU) 808, and the processor 802 is coupled through the bus 806 to the GPU 808. The GPU 808 performs any number of graphics functions and actions within the computing system 800, such as rendering or manipulating graphics images, graphics frames, videos, or the like, to be displayed to a user of the computing system 800. As described above with reference to FIG. 1, the desktop composition module in some embodiments may be implemented as part of the graphics driver GD of the computer system 800, and this graphics driver controls programming and operation of the GPU 808.

An image capture device 810, such as a camera, scanner, infrared sensor, or other type of suitable device, is also coupled to the bus 806 to communicate with the processor 802 and memory device 804. The processor 802 is coupled through the bus 806 to one or more displays 812, which may include displays that are internal to or “built-in” component of the computing system 800. The displays 812 may also include display screens that are external to the computing system 800. Examples of such a computing system 800 include mobile computing systems, such as cell or smart phones, tablets, 2-in-1 computers, notebook computers and the like. The display devices 812 may include a computer monitor, television, or projector, among others, that is externally connected to the computing system 800. In some examples of the computing system 800, the display devices 812 may be head-mounted display devices having a display capacity via projection, digital display, filtering incoming light, and the like.

The processor 802 is also be connected through the bus 806 to an input/output (I/O) interface 814 configured to connect the computing system 800 to one or more I/O devices 816. The I/O devices 816 may include, for example, a keyboard, a pointing device such as a touchpad or a touchscreen, a storage device, and other types of electronic devices. The I/O devices 816 may include built-in components of the computing system 800 or may be devices that are externally connected to the computing system. In some cases, the I/O devices 816 are touchscreen devices integrated within a display device, such as one or more of the display devices 812.

The computing system 800 may also include another storage device or devices 818, which may include a physical memory such as a hard drive, an optical drive, a thumb drive, an array of drives, or any combinations thereof. The storage device 818 may also include remote storage drives. A network interface controller (NIC) 820 connects the computing system 800 to a network 822, which may be a wide area network (WAN), local area network (LAN), the Internet, or the like. The computing system 800 is powered through a power supply unit (PSU) 824 that communicates with the processor 802 through the bus 806 to communicate control signals or status signals to the PSU. The PSU 824 includes a rechargeable power source such as a battery in some embodiments, and is coupled to a power source 826 external the computing system 800 to receive electrical power, charge the rechargeable power source when present, and to supply provide electrical power to the other components in the computing system 800. The block diagram of FIG. 8 is not intended to indicate that the computing system 800 must include all the components shown. Furthermore, the computing system 800 may include any number of additional components not shown in FIG. 8 based on the specific implementation or utilization of the computing system.

### ADDITIONAL EXAMPLES

Each of the following non-limiting examples may stand on its own, or may be combined in various permutations or combinations with one or more of the other examples.

Example 1 is a method, comprising: determining one or more areas of a display to remain active in response to received user input; determining one or more areas of the display to be dimmed in response to the received user input; and dimming the one or more areas of the display to be dimmed to reduce a power consumption of the display.

Example 2 is the subject matter of Example 1, wherein the received user input comprises at least one of: cursor information received from a mouse; keystroke information received from a keyboard; touch information received from a touch screen; a position of the eyes of the user indicating a location on the display where the user is looking; a voice command from the user; manual input received from a user; or a power policy setting of an electronic device including the display.

Example 3 is the subject matter of any one or more of Examples 1-2, wherein the display comprises a plurality of pixels, and wherein dimming the one or more areas of the display to be dimmed comprises dimming at least some of the pixels of the display in the one or more areas of the display to be dimmed.

Example 4 is the subject matter of any one or more of Examples 1-3, wherein dimming at least some of the pixels of the display in the one or more areas of the display to be dimmed comprises changing a color of at least some of the plurality of pixels of the display in the one or more areas of the display to be dimmed.

Example 5 is the subject matter of any one or more of Examples 1-4, wherein changing a color of at least some of the plurality of pixels of the display in the one or more areas of the display to be dimmed comprises changing the color to black.

Example 6 is the subject matter of any one or more of Examples 1-5, wherein the display includes a plurality of displays and wherein dimming one or more areas of the display to be dimmed comprises dimming one or more areas on each of the plurality of displays.

Example 7 is the subject matter of any one or more of Examples 1-6, wherein dimming one or more areas on each of the plurality displays comprises turning off one or more of the plurality of displays.

Example 8 is the subject matter of any one or more of Examples 1-7 further comprising enabling and disabling dimming the one or more areas of the display to be dimmed in response to received user input.

Example 9 is a non-transitory machine-readable medium storing a program executable by at least one processing unit of an electronic device including a display, the program comprising sets of instructions for: determining one or more areas of the display to remain active in response to received user input; determining one or more areas of the display to be dimmed in response to the received user input; and dimming the one or more areas of the display to be dimmed to reduce a power consumption of the display.

Example 10 is the subject matter of Example 9, wherein the program comprises a set of instructions in a desktop composition module of the electronic device.

Example 11 is the subject matter of any one or more of Examples 9-10, wherein the electronic device executes the Windows operating system, and wherein the desktop composition module comprises the desktop windows manager (DWM) of the Windows operating system.

Example 12 is the subject matter of any one or more of Examples 9-11, wherein the program comprises a set of instructions in a graphics driver of the electronic device.

Example 13 is the subject matter of any one or more of Examples 9-12, wherein the program further comprises a set of instructions of a plugin of the graphics driver.

Example 14 is the subject matter of any one or more of Examples 9-13, wherein the plugin comprises a set of instructions for receiving, from an operating system of the electronic device, the received user input.

Example 15 is a system, comprising: one or more displays; a set of processors; and a non-transitory computer-readable medium storing a set of instructions that when executed by at least one processor in the set of processors cause the at least one processor to: determine one or more areas of the one more displays that are to remain active in response to user input; determine one or more areas of the one more displays that are to be dimmed in response to the user input; and dim the one or more areas of the one or more displays to be dimmed to reduce a power consumption of the one or more displays.

Example 16 is the subject matter of Example 15, wherein the set of instructions stored in the non-transitory computer-readable medium comprise instructions in a desktop composition module of the system.

Example 17 is the subject matter of any one or more of Examples 15-16, wherein the non-transitory computer-readable medium stores instructions of the Windows operating system, and wherein the desktop composition module comprises the desktop windows manager (DWM) of the Windows operating system.

Example 18 is the subject matter of any one or more of Examples 15-17, wherein the set of instructions stored in the non-transitory computer-readable medium further comprise a set of instructions of a graphics driver of the system.

Example 19 is the subject matter of any one or more of Examples 15-18, wherein the set of instructions stored in the non-transitory computer-readable medium include a plugin of the graphics driver.

Example 20 is the subject matter of any one or more of Examples 15-19, wherein the graphics driver includes a dimming shader program and the dimming shader program includes the plugin comprising a set of instructions for receiving, from an operating system of the system, the user input.

The above description illustrates various embodiments of the present disclosure along with examples of how aspects of the particular embodiments may be implemented. The above examples should not be deemed to be the only embodiments and are presented to illustrate the flexibility and advantages of the particular embodiments covered by the following claims. Based on the embodiments described in the present disclosure, other arrangements, embodiments, implementations and equivalents may be employed without departing from the scope of the present disclosure.

What is claimed is:

1. A method, comprising:
determining one or more areas of a display to remain active in response to received user input;
determining one or more areas of the display to be dimmed in response to the received user input; and
dimming the one or more areas of the display to be dimmed to reduce a power consumption of the display.

2. The method of claim 1, wherein the received user input comprises at least one of:
cursor information received from a mouse;
keystroke information received from a keyboard;
touch information received from a touch screen;
a position of the eyes of the user indicating a location on the display where the user is looking;
a voice command from the user;
manual input received from a user; or
a power policy setting of an electronic device including the display.

3. The method of claim 1, wherein the display comprises a plurality of pixels, and wherein dimming the one or more areas of the display to be dimmed comprises dimming at least some of the pixels of the display in the one or more areas of the display to be dimmed.

4. The method of claim 3, wherein dimming at least some of the pixels of the display in the one or more areas of the display to be dimmed comprises changing a color of at least some of the plurality of pixels of the display in the one or more areas of the display to be dimmed.

5. The method of claim 4, wherein changing a color of at least some of the plurality of pixels of the display in the one or more areas of the display to be dimmed comprises changing the color to black.

6. The method of claim 1, wherein the display includes a plurality of displays and wherein dimming one or more areas of the display to be dimmed comprises dimming one or more areas on each of the plurality of displays.

7. The method of claim 6, wherein dimming one or more areas on each of the plurality displays comprises turning off one or more of the plurality of displays.

8. The method of claim 1, further comprising enabling and disabling dimming the one or more areas of the display to be dimmed in response to received user input.

9. A non-transitory machine-readable medium storing a program executable by at least one processing unit of an electronic device including a display, the program comprising sets of instructions for:
determining one or more areas of the display to remain active in response to received user input;
determining one or more areas of the display to be dimmed in response to the received user input; and
dimming the one or more areas of the display to be dimmed to reduce a power consumption of the display.

10. The non-transitory machine-readable medium of claim 9, wherein the program comprises a set of instructions in a desktop composition module of the electronic device.

11. The non-transitory machine-readable medium of claim 10, wherein the electronic device executes the Windows operating system, and wherein the desktop composition module comprises the desktop windows manager (DWM) of the Windows operating system.

12. The non-transitory machine-readable medium of claim 9, wherein the program comprises a set of instructions in a graphics driver of the electronic device.

13. The non-transitory machine-readable medium of claim 12, wherein the program further comprises a set of instructions of a plugin of the graphics driver.

14. The non-transitory machine-readable medium of claim 9, wherein the plugin comprises a set of instructions for receiving, from an operating system of the electronic device, the received user input.

15. A system, comprising:
one or more displays;
a set of processors; and
a non-transitory computer-readable medium storing a set of instructions that when executed by at least one processor in the set of processors cause the at least one processor to:
determine one or more areas of the one more displays that are to remain active in response to user input;
determine one or more areas of the one more displays that are to be dimmed in response to the user input; and
dim the one or more areas of the one or more displays to be dimmed to reduce a power consumption of the one or more displays.

16. The system of claim 15, wherein the set of instructions stored in the non-transitory computer-readable medium comprise instructions in a desktop composition module of the system.

17. The system of claim 16, wherein the non-transitory computer-readable medium stores instructions of the Windows operating system, and wherein the desktop composition module comprises the desktop windows manager (DWM) of the Windows operating system.

18. The system of claim 15, wherein the set of instructions stored in the non-transitory computer-readable medium further comprise a set of instructions of a graphics driver of the system.

19. The system of claim 18, wherein the set of instructions stored in the non-transitory computer-readable medium include a plugin of the graphics driver.

20. The non-transitory machine-readable medium of claim 19, wherein the graphics driver includes a dimming shader program and the dimming shader program includes the plugin comprising a set of instructions for receiving, from an operating system of the system, the user input.
